(19) United States
(12) Patent Application Publication
(10) Pub. No.: US 2024/0243625 A1
(43) Pub. Date: Jul. 18, 2024

(54) ROTATING ELECTRIC MACHINE

(71) Applicant: Honda Motor Co., Ltd., Tokyo (JP)

(72) Inventors: Daiki Atsuda, Tokyo (JP); Masashi Yokoi, Tokyo (JP); Masato Takehara, Tokyo (JP)

(21) Appl. No.: 18/401,555

(22) Filed: Dec. 31, 2023

(30) Foreign Application Priority Data
Jan. 18, 2023 (JP) 2023-005604

(51) Int. Cl. H02K 1/276; H02K 21/14

(52) U.S. Cl. CPC H02K 1/276; H02K 21/14; H02K 2213/03

(57) ABSTRACT

A rotating electric machine including a rotor and a stator. The rotor includes a rotor core in which magnet accommodation holes and flux barriers are formed and permanent magnets accommodated in the magnet accommodation holes. The permanent magnet includes a first and second surfaces opposed to each other, the magnet accommodation hole is formed with a first and second opposing surfaces opposing the first and second surfaces, the first opposing surface is located on an outer peripheral surface side of the second opposing surface, a gap is provided between the first opposing surface and the first surface, the rotor core includes a protrusion protruded from the first opposing surface toward the first surface, and the protrusion is protruded toward a predetermined portion on an end portion side between the end portion and a center portion in a width direction of the first surface.

### CROSS-REFERENCE TO RELATED APPLICATION

This application is based upon and claims the benefit of priority from Japanese Patent Application No. 2023-005604 filed on Jan. 18, 2023, the content of which is incorporated herein by reference.

### BACKGROUND OF THE INVENTION

### Field of the Invention

This invention relates to a rotating electric machine including a rotor in which a permanent magnet is embedded.

### Description of the Related Art

Conventionally, there has been known a rotating electric machine in which a coercive force of a plurality of permanent magnets is adjusted to improve thermal demagnetization resistance against magnetic field fluctuation caused by a current flowing through a stator winding. Such a rotating electric machine is described, for example, in Japanese Unexamined Patent Publication No. 2020-036518 (JP2020-036518A).

In general, when a permanent magnet is incorporated in such as a rotating electric machine including a magnetic circuit, demagnetization factor increases at a corner portion of the permanent magnet. Therefore, in consideration of this point, it is preferable to efficiently improve the demagnetization resistance.

### SUMMARY OF THE INVENTION

An aspect of the present invention is a rotating electric machine including a rotor rotating about an axial line, and a stator disposed around an outer peripheral surface of the rotor to generate a rotating magnetic field for the rotor. The rotor includes a rotor core in which a plurality of magnet accommodation holes in a circumferential direction and flux barriers are formed, each of the flux barriers being adjacent to each of the plurality of magnet accommodation holes, and a plurality of permanent magnets, each having a width extending in a linear shape or an arc shape in a width direction and a thickness extending in a thickness direction perpendicular to the width direction, in a vertical cross-section perpendicular to the axial line, and being accommodated in the each of the plurality of magnet accommodation holes. Each of the plurality of permanent magnets includes a first surface and a second surface extending in the width direction and opposed to each other. The each of the plurality of magnet accommodation holes is formed with a first opposing surface opposing the first surface and a second opposing surface opposing the second surface. The first opposing surface is located further on an outer peripheral surface side of the rotor than the second opposing surface. A gap is provided between the first opposing surface and the first surface along the width direction. The rotor core includes a protrusion protruded from the first opposing surface toward the first surface. The protrusion is protruded toward a predetermined portion on a side of an end portion between the end portion and a center portion in the width direction of the first surface.

### BRIEF DESCRIPTION OF THE DRAWINGS

The objects, features, and advantages of the present invention will become clearer from the following description of embodiments in relation to the attached drawings, in which:

FIG. 1 is a cross-sectional view perpendicular to an axial line and illustrating a configuration of a main part of a rotating electric machine according to an embodiment of the present disclosure;

FIG. 2 is an enlarged view of a main part of FIG. 1 and illustrating a configuration of a single magnetic pole portion;

FIG. 3 is a diagram schematically illustrating an operation of magnetic flux in the rotating electric machine of FIG. 1;

FIG. 4 is an enlarged view of a peripheral area of a permanent magnet included in the magnetic pole portion of FIG. 2;

FIG. 5A is an enlarged view of a part A in FIG. 4;

FIG. 5B is an enlarged view of a part B in FIG. 4;

FIG. 6 is a view schematically illustrating a flow of the magnetic flux caused by the rotating electric machine according to the embodiment of the present invention;

FIG. 7 is a contour diagram illustrating an example of a demagnetization factor in a corner portion of the permanent magnet;

FIG. 8A is a diagram illustrating a relationship between a position of the protrusion and the demagnetization factor in a predetermined portion of the rotating electric machine according to the embodiment of the present invention;

FIG. 8B is a diagram illustrating a relationship between a position of the protrusion and the demagnetization factor in another predetermined portion of the rotating electric machine according to the embodiment of the present invention;

FIG. 9 is a diagram illustrating a modification of FIG. 2;

FIG. 10 is an enlarged view of a main part of FIG. 9; and

FIG. 11 is a diagram illustrating a modification of the protrusion included in the rotating electric machine according to the embodiment of the present invention.

### DETAILED DESCRIPTION OF THE INVENTION

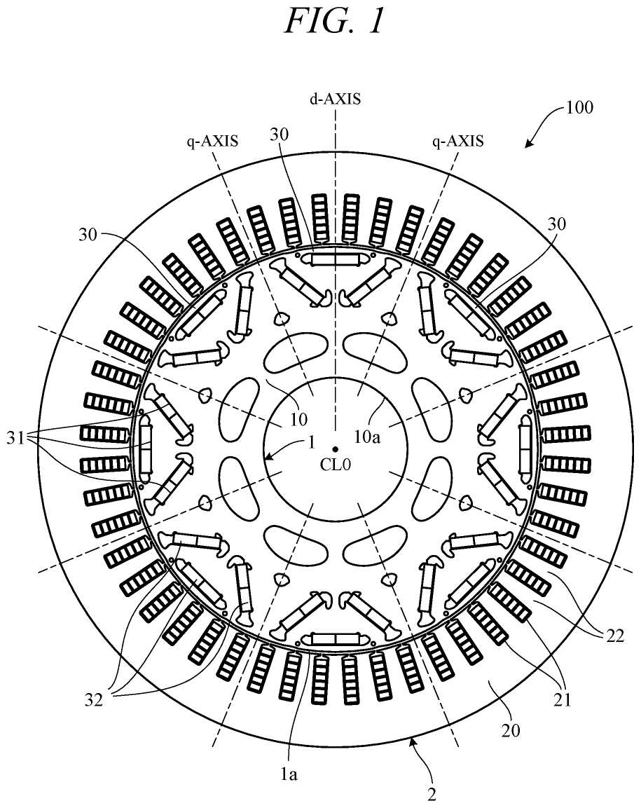

An embodiment of the present invention will be described with reference to FIGS. 1 to 11. A rotating electric machine according to an embodiment of the present invention is mounted in a hybrid vehicle or an electric vehicle, and can be used as an electric motor for driving a vehicle, and can also be used as a generator. The rotating electric machine can be mounted on anything other than a vehicle, and can be used in various applications.

FIG. 1 is a cross-sectional view perpendicular to an axial line CL0 and illustrating a configuration of a main part of a rotating electric machine according to an embodiment of the present disclosure. As illustrated in FIG. 1, the rotating electric machine 100 includes a rotor 1 that rotates about an axial line CL0, and a stator 2 that is disposed so as to surround an outer peripheral surface 1a of the rotor 1.

The rotor 1 includes a rotor core 10 having a substantially annular shape centered on the axial line CL0, and a plurality of circumferential magnetic pole portions 30 formed in the rotor core 10. A rotor shaft (not shown) constituting an output shaft of the rotating electric machine 100, for example, is fitted to the inner peripheral surface 10a of the rotor core 10, and the rotor 1 rotates integrally with the rotor shaft. The outer peripheral surface 1a of the rotor 1 corresponds to an outer peripheral surface of the rotor core 10. The rotor core 10 is formed by stacking a plurality of magnetic steel sheets made of metal, which are magnetic bodies, in the axial direction.

The plurality of magnetic pole portions 30 are provided at equal intervals in the circumferential direction. In the example of FIG. 1, eight magnetic pole portions 30 are provided every 45°. Each magnetic pole portion 30 includes a plurality of (three in FIG. 1) magnet accommodation holes 31 formed in the rotor core 10, and a plurality of permanent magnets 32 accommodated in the magnet accommodation holes 31. A single or a plurality of permanent magnets 32 may be accommodated in each magnet accommodation hole 31. In FIG. 1, two permanent magnets 32 are accommodated in a single magnet accommodation hole 31 side by side in the longitudinal direction. However, the number of permanent magnets 32 accommodated in the single magnet accommodation hole 31 may be one, may be three or more. In the following description, even when a plurality of permanent magnets 32 are accommodated in the single magnet accommodation hole 31, the entire permanent magnet 32 is treated as one permanent magnet.

In the present embodiment, at the center of the magnetic pole portion 30 in the circumferential direction, an axis extending in the radial direction is defined as a d-axis. Further, at an end portion in the circumferential direction of the magnetic pole portion 30, an axis extending in the radial direction and separated by 90° at an electrical angle with respect to the d-axis is defined as a q-axis.

The stator 2 includes a stator core 20 having a substantially annular shape centered on the axial line CL0, which is disposed at a predetermined distance from the outer peripheral surface 1a of the rotor 1 in the radial direction, and a coil 21 attached to the stator core 20. The stator core 20 is formed by stacking a plurality of magnetic steel sheets made of metal, which are magnetic bodies, in the axial direction. At the inner peripheral surface of the stator core 20, a plurality of teeth 22 in the circumferential direction are projected toward the radially inner side. A slot is formed between the adjacent teeth 22. The coil 21 is configured by a winding wound around the teeth 22.

When a current flows through the coil 21, a magnetic field is generated in the stator 2. This magnetic field interacts with the magnetic field generated by the permanent magnets 32 of the magnetic pole portion 30 of the rotor 1, thereby rotating the rotor 1.

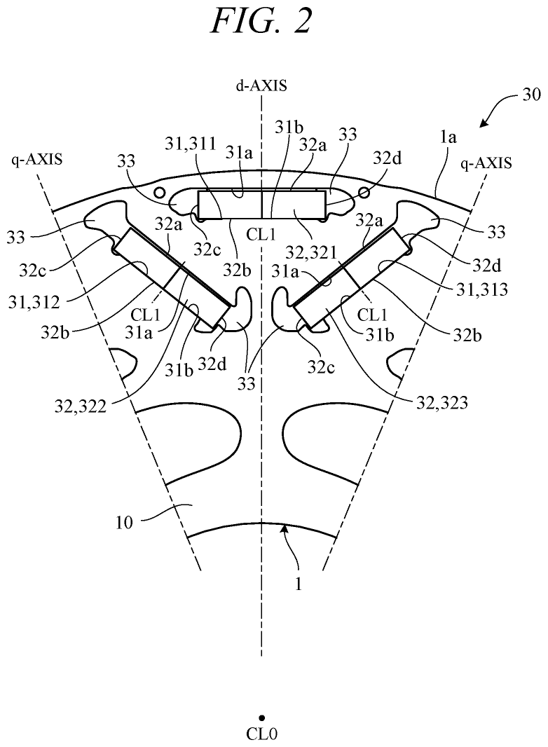

FIG. 2 is an enlarged view of a main part of FIG. 1, and is a view illustrating a configuration of a single magnetic pole portion 30. As illustrated in FIG. 2, the three magnet accommodation holes 31 in the magnetic pole portion 30, that is, a first magnet accommodation hole 311, a second magnet accommodation hole 312, and a third magnet accommodation hole 313 are provided to be symmetric with respect to the d-axis. More specifically, the first magnet accommodation hole 311 extend in the circumferential direction to be substantially orthogonal to the d-axis, and is formed to be symmetric with respect to the d-axis. The second magnet accommodation hole 312 and the third magnet accommodation hole 313 extend obliquely in the radial direction so that each inner end portion in the radial direction is closer to the d-axis than to each outer end portion in the radial direction, and are formed in a substantially V-shape with the d-axis as the center. Hereinafter, the first magnet accommodation hole 311, the second magnet accommodation hole 312, and the third magnet accommodation hole 313 will be collectively referred to as the magnet accommodation holes 311 to 313 or simply the magnet accommodation hole 31, in some cases.

The three permanent magnets 32 are a first permanent magnet 321 accommodated in the first magnet accommodation hole 311, a second permanent magnet 322 accommodated in the second magnet accommodation hole 312, and a third permanent magnet 323 accommodated in the third magnet accommodation hole 313, and the magnetic pole portion 30 has a so-called V type magnet arrangement. Hereinafter, the first permanent magnet 321, the second permanent magnet 322, and the third permanent magnet 323 will be collectively referred to as the permanent magnets 321 to 323 or simply the permanent magnet 32, in some cases. The permanent magnets 321 to 323 have identical shapes with one another, and each of them is formed in a flat plate shape having a substantially rectangular cross-section when viewed from the axial direction and extending in the axial direction to correspond to the shape of each of the magnet accommodation holes 311 to 313. Various magnets such as a neodymium magnet and a ferrite magnet can be used for the permanent magnets 321 to 323.

In a cross-section perpendicular to the axial line CL0, a longer direction of the permanent magnets 321 to 323 will be referred to as a width, and a shorter direction will be referred to as a thickness. Each of the permanent magnets 321 to 323 has a pair of an outer side surface 32a and an inner side surface 32b extending in the width direction (longer direction), and a pair of end surfaces 32c and 32d extending in the thickness direction (shorter direction). All the outer side surfaces 32a of the permanent magnets 321 to 323 are located on an outer side in the radial direction (on an outer peripheral surface 1a side of the rotor 1) of the inner side surface 32b. The permanent magnets 321 to 323 are each configured in its entirety to be symmetric with respect to a center line CL1 extending in the thickness direction through the center in the width direction. The center line CL1 of the first permanent magnet 321 coincides with the d-axis.

All the permanent magnets 321 to 323 are magnetized in the thickness direction. For example, the outer side surfaces 32a of the permanent magnets 321 to 323 are each magnetized with the North Pole, and the inner side surfaces 32b are each magnetized with the South Pole. In the magnetic pole portions 30 adjacent to each other in the circumferential direction, the magnetization directions are opposite to each other.

In the rotor core 10, a flux barrier 33 is formed continuously with the magnet accommodation hole 31. The flux barrier 33 is adjacent to each of the pair of end surfaces 32c and 32d of the permanent magnet 32, and extends outward in the width direction of the permanent magnet 32 (for example, outward in the radial direction). The flux barrier 33 is an air layer, and is larger in magnetic resistance than the rotor core 10. The provision of the flux barrier 33 enables suppression of the magnetic flux generated by the permanent magnet 32 from being magnetically short-circuited on the rotor side. The flux barrier 33 can be filled with a resin that is lower in magnetic permeability than the rotor core 10, so that the flux barrier 33 can be formed as a resin layer.

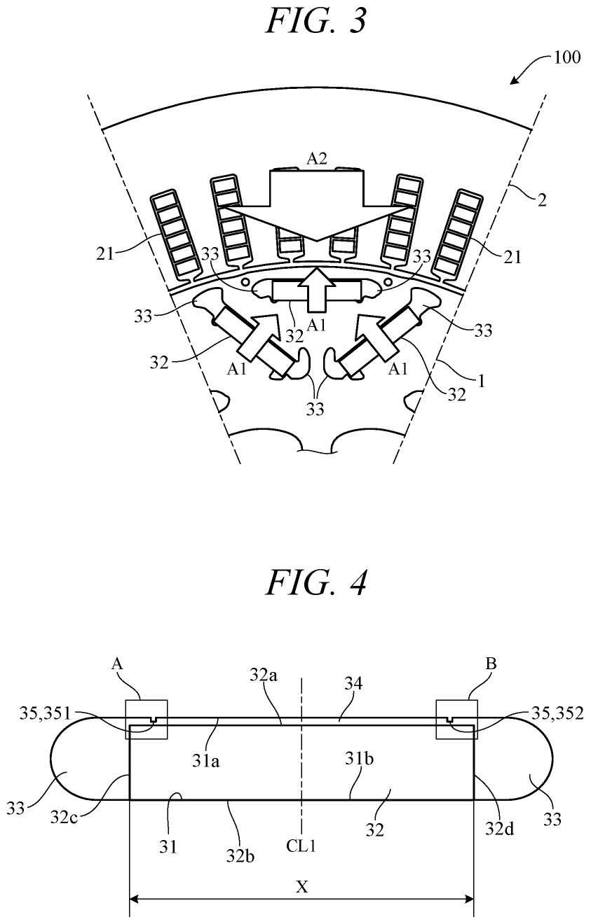

In such a rotating electric machine 100, as schematically illustrated in FIG. 3, a reverse magnetic field A2 by the coils 21 acts on the permanent magnet 32 in a direction opposite to a magnetization direction A1 of the permanent magnet 32. In this situation, although the illustration is omitted, in a B-H curve (a magnetization curve) representing a relationship between magnetic flux density B and intensity H of the magnetic field, in a case where an operation point represented by a permeance coefficient Pc does not exceed a bending point of the B-H curve, this means reversible demagnetization, and the magnetic flux density of the permanent magnet 32 can return to its original state. However, when the reverse magnetic field becomes larger or the permanent magnet 32 becomes higher in temperature, the operation point may exceed the bending point, thereby leading to irreversible demagnetization.

In particular, the magnetic flux tends to concentrate on a corner portion of the permanent magnet 32, and the permeance coefficient Pc is low. Hence, even in a case where the flux barrier 33 is provided to suppress the magnetic flux from being short-circuited, the irreversible demagnetization is likely to occur. For this reason, in order to suppress such irreversible demagnetization and efficiently improve demagnetization resistance (thermal demagnetization resistance) of the permanent magnet 32, the rotating electric machine 100 is configured as follows in the present embodiment.

FIG. 4 is an enlarged view of a peripheral area of the permanent magnet 32 (the first permanent magnet 321, the second permanent magnet 322, and the third permanent magnet 323). In FIG. 4, the flux barriers 33 are illustrated in a simple manner. As illustrated in FIG. 4, the magnet accommodation hole 31 includes an outer opposing surface 31a opposing the outer side surface 32a of the permanent magnet 32 and an inner opposing surface 31b opposing the inner side surface 32b of the permanent magnet 32. The outer opposing surface 31a extends in substantially parallel with the outer side surface 32a, and the inner opposing surface 31b extends in substantially parallel with the inner side surface 32b. The permanent magnet 32 is accommodated in the magnet accommodation hole 31 with the inner side surface 32b being in contact with the inner opposing surface 31b.

The length from the outer opposing surface 31a to the inner opposing surface 31b is longer than the thickness of the permanent magnet 32. Therefore, a gap 34 extends along the width direction of the permanent magnet 32 between the outer opposing surface 31a and the outer side surface 32a. In a state in which the gap 34 is provided in this manner, the permanent magnet 32 is fixed at a predetermined position of the magnet accommodation hole 31 with use of a fixing means such as an adhesive. The gap 34 may be filled with a resin material as a fixing means, and thus the permanent magnet 32 is fixed.

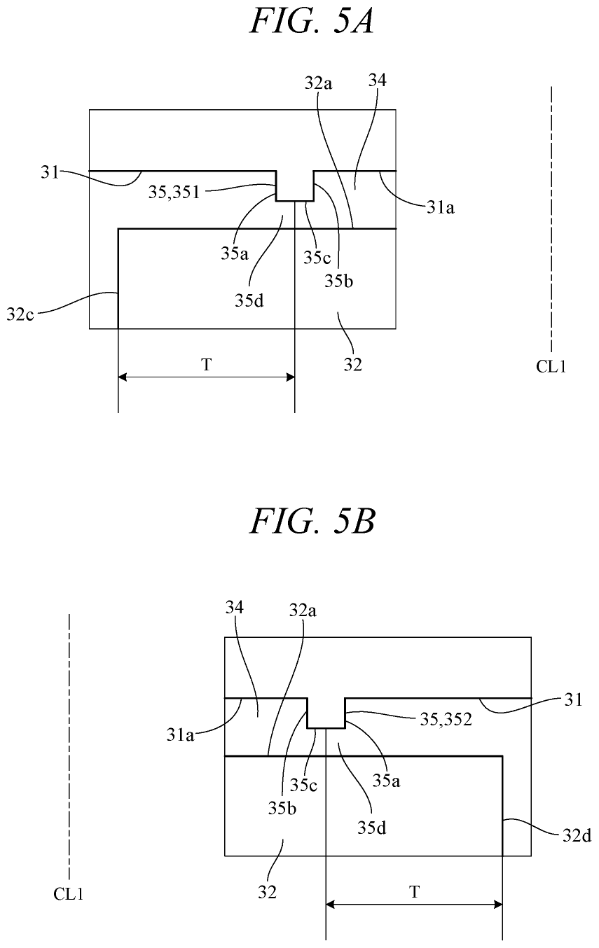

On the outer opposing surface 31a, a pair of protrusions 35 are provided to protrude toward the outer side surface 32a of the permanent magnet 32 so as to be symmetric with respect to the center line CL1. In the following, for the sake of convenience, the pair of protrusions 35 will be referred to as a first protrusion 351 and a second protrusion 352, in some cases. FIG. 5A is an enlarged view of a part A in FIG. 4, and FIG. 5B is an enlarged view of a part B in FIG. 4.

As illustrated in FIG. 5A, the first protrusion 351 is located between the end surface 32c of the permanent magnet 32 and the center line CL1. More specifically, the first protrusion 351 is located in the vicinity of a corner portion where the outer side surface 32a and the end surface 32c intersect with each other, and is located on the center line CL1 side of the end surface 32c. Preferably, the first protrusion 351 is located between the end surface 32c and the center line CL1 and located closer to the end surface 32c than the center line CL1. In other words, in a case where X represents the total length in the width direction of the permanent magnet 32 (see FIG. 4) and T represents the distance from the end surface 32c of the permanent magnet 32 to the center position in the width direction of the first protrusion 351, T is set to be larger than 0 and smaller than 0.5X, and is preferably smaller than 0.25X. More preferably, the first protrusion 351 is provided to satisfy the following formula (I).

$$0 < T \leq 0.2 \cdot X \qquad ( I )$$

As illustrated in FIG. 5B, the second protrusion 352 is also configured similarly to the first protrusion 351. That is, in a case where T represents the distance from the end surface 32d of the permanent magnet 32 to the center position in the width direction of the protrusion 35, the second protrusion 352 is provided so that T is larger than 0 and smaller than 0.5X, is preferably smaller than 0.25X, and more preferably satisfies the above formula (I).

As illustrated in FIGS. 5A and 5B, each of the protrusions 35 (the first protrusion 351 and the second protrusion 352) has a substantially rectangular shape in cross-section perpendicular to the axial line CL0, and includes a pair of side surfaces 35a and 35b extending substantially in parallel with the thickness direction of the permanent magnet 32, and a tip end surface 35c extending substantially in parallel with the width direction. The side surfaces 35a is located on a corner portion side (on the end surface 32c or 32d side) of the permanent magnet 321, and the side surface 35b is located on a center line CL1 side. The side surfaces 35a and 35b of the first protrusion 351 are located between the end surface 32c of the permanent magnet 32 and the center line CL1, that is, the side surface 35a is located on the center line CL1 side of the end surface 32c, and the side surface 35b is located on the end surface 32c side of the center line CL1. The side surfaces 35a and 35b of the second protrusion 352 are located between the end surface 32d of the permanent magnet 32 and the center line CL1, that is, the side surface 35a is located on the center line CL1 side of the end surface 32d, and the side surface 35b is located on the end surface 32d side of the center line CL1.

Between the tip end surface 35c of the protrusion 35 and the outer side surface 32a of the permanent magnet 32, a gap 35d spaced apart by a predetermined length is provided. Accordingly, when the permanent magnet 32 is inserted into the magnet accommodation hole 31, it is possible to prevent the permanent magnet 32 from coming into contact with an edge portion of the magnet accommodation hole 31 and damaging the permanent magnet 32. As long as the permanent magnet 32 is insertable without contacting the edge portion of the magnet accommodation hole 31, the gap 35d is preferably as small as possible.

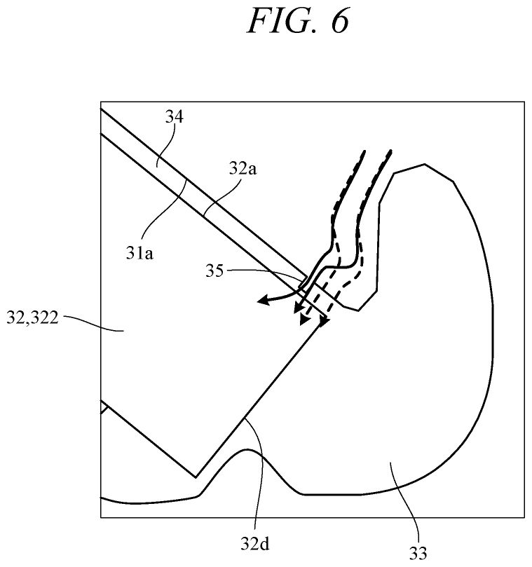

FIG. 6 is a view schematically illustrating changes of the flow of the magnetic flux caused by the provision of the protrusion 35, and illustrates, as an example, an enlarged peripheral area of a corner portion on the end surface 32d side of the second permanent magnet 322. Dotted arrows in FIG. 6 indicate flow of the magnetic flux in a case where the protrusion 35 is not provided, and solid arrows indicate flow of the magnetic flux in a case where the protrusion 35 is provided. As illustrated in FIG. 6, in the case where the protrusion 35 is not provided, the magnetic flux concentrates on the corner portion of the permanent magnet 32 (the dotted arrows). On the other hand, in the case where the protrusion 35 is provided, the magnetic flux bypasses the corner portion, and flows across the protrusion 35 into the permanent magnet 32 (the solid arrows). Therefore, the flow of the magnetic flux is dispersed, and the concentration of the magnetic flux on the corner portion is alleviated.

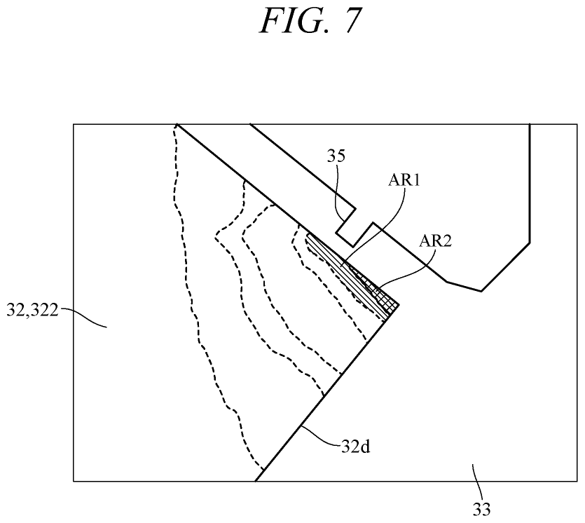

FIG. 7 is a contour diagram illustrating a demagnetization factor in the vicinity of the corner portion of the permanent magnet 32 (the second permanent magnet 322). Dotted lines in FIG. 7 indicate a contour diagram in the case where the protrusion 35 is not provided. As indicated by the dotted lines in FIG. 7, the demagnetization factor increases toward the corner portion of the permanent magnet 32, and becomes the maximum in an area AR1 (hatching). An area AR2 (hatching) indicated by solid lines in FIG. 7 is an area where the demagnetization factor becomes the maximum (an area where the demagnetization factor is equal to or larger than a predetermined value) in the case where the protrusion 35 is provided, and the magnitudes of the demagnetization factors in the area AR1 and the area AR2 are equal to each other. If changes in the demagnetization factor in the case where the protrusion 35 is provided are illustrated in a contour diagram, the diagram becomes complicated. Therefore, in FIG. 7, only the area AR2 corresponding to the area AR1 is illustrated.

In the case where the protrusion 35 is provided, the concentration of the magnetic flux on the corner portion of the permanent magnet 32 is alleviated, as described above. Therefore, as illustrated in FIG. 7, the area AR2 is smaller than the area AR1. That is, the range where the demagnetization factor in the vicinity of the corner portion is equal to or larger than the predetermined value is reduced by the provision of the protrusion 35. This enables suppression of the degree of demagnetization in the corner portion of the permanent magnet 32.

In the present embodiment, the protrusion 35 is provided to satisfy the above formula (I). Supposing that a distance T (FIGS. 5A and 5B) from the end surfaces 32c and 32d of the permanent magnet 32 to the center of the protrusion 35 is 0, the magnetic flux flows to the corner portion of the permanent magnet 32 via the protrusion 35. Hence, it is not possible to suppress the demagnetization in the corner portion. For this reason, it is necessary to provide the protrusion 35 to satisfy 0<T. In addition, in a case where the distance T from the corner portion is too long, it is not possible to bypass the magnetic flux toward the corner portion via the protrusion 35, and the effect of suppressing the demagnetization in the corner portion is not obtainable. For this reason, the protrusion 35 is preferably provided to satisfy T≤0.2X.

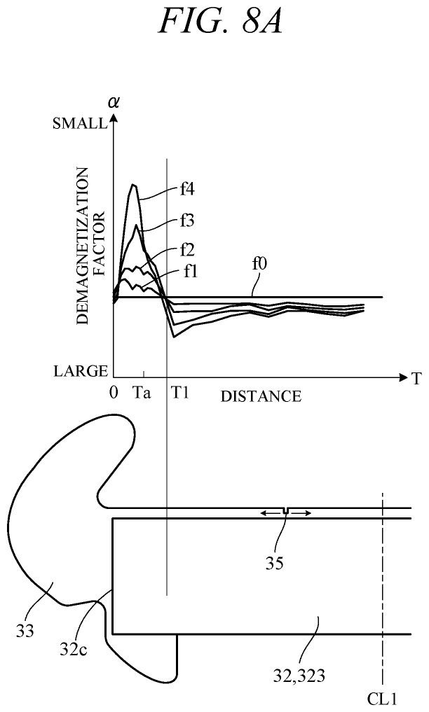

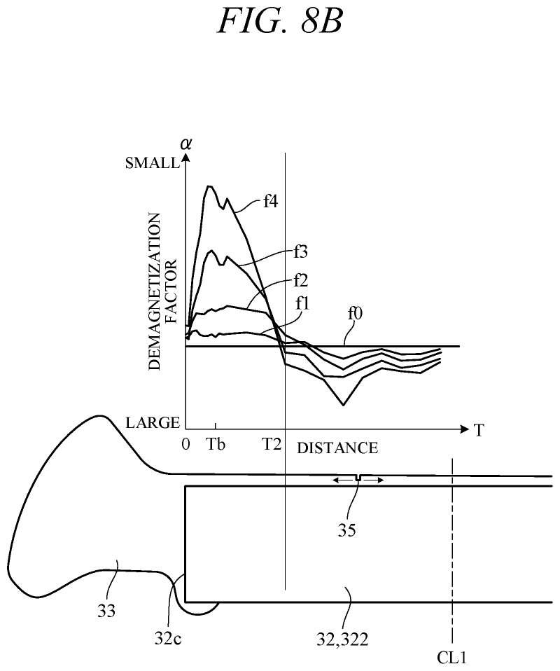

Analysis results of the demagnetization factor, in a case where the position of the protrusion 35 is changed in the width direction of the permanent magnet 32, are as follows. FIG. 8A is a diagram illustrating an example of an analysis result in the vicinity of a corner portion (a corner portion located on an inner side in the radial direction) of the third permanent magnet 323, and FIG. 8B is a diagram illustrating an example of an analysis result in the vicinity of a corner portion (a corner portion located on an outer side in the radial direction) of the second permanent magnet 322. In FIGS. 8A and 8B, the demagnetization resistance is evaluated by a demagnetization factor α, after the permanent magnet 32 is raised to a predetermined temperature (for example, 180° C.) and a reverse magnetic field is applied. In FIGS. 8A and 8B, the horizontal axis represents the distance T from the corner portion (the end surface 32c) of the permanent magnet 32, and the vertical axis represents the demagnetization factor α. The demagnetization factor a is all set to a negative value, and as the demagnetization factor α increases, the negative value is larger. In addition, as the demagnetization factor α decreases (toward upper sides in FIGS. 8A and 8B), the demagnetization resistance increases.

A characteristic f0 in FIGS. 8A and 8B represents a characteristic in a case where the protrusion 35 is not provided, and characteristics f1 to f4 represent characteristics in a case where the heights (protrusion lengths) of the protrusion 35 are respectively 0.05 mm, 0.1 mm, 0.15 mm, and 0.2 mm. As illustrated in FIG. 8A, in all the characteristics f1 to f4, the demagnetization factor α gradually decreases, as the distance T increases from 0. Then, the demagnetization factor α becomes the minimum near a distance Ta, then gradually increases as the distance T increases, and becomes larger than the demagnetization factor of the characteristic f0 at a distance T1. In addition, in the range where the distance T is 0 to T1, as the protrusion 35 becomes higher, the demagnetization factor α is suppressed more, and the effect of suppressing the demagnetization becomes the maximum, in a case where the height is 0.2 mm (the characteristic f4).

FIG. 8B also indicates a similar tendency to FIG. 8A. That is, as indicated in FIG. 8B, in all the characteristics f1 to f4, the demagnetization factor α gradually decreases, as the distance T increases from 0. Then, the demagnetization factor α becomes the minimum near a distance Tb, then gradually increases, as the distance T increases, and becomes larger than the demagnetization factor of the characteristic f0 at the distance T2. In addition, in the range where the distance T is 0 to T2, as the protrusion 35 becomes higher, the demagnetization factor α is suppressed more.

Here, T1 and T2 are both 0.2X or smaller, and satisfy the above formula (I). Accordingly, in the case where the protrusion 35 is provided to satisfy the above formula (I), the demagnetization factor of the permanent magnet 32 can be favorably suppressed. In addition, as the height (the protrusion amount) of the protrusion 35 increases, the effect of demagnetization suppression increases. The range where the effect of the demagnetization suppression is obtained varies depending on the arrangement of the permanent magnet 32. For example, the effect is obtained in the range where 0<T≤0.1X, in some cases. Therefore, the position of the protrusion 35 may be changed within the range of the above formula (I) in accordance with the arrangement of the permanent magnet 32.

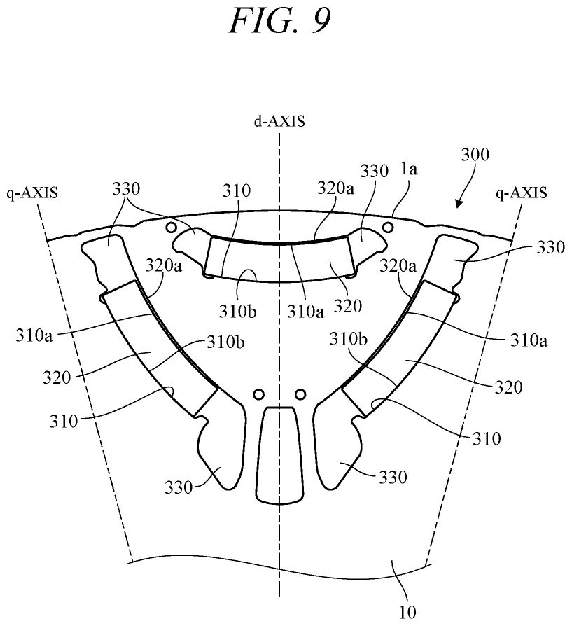

Heretofore, the case where the permanent magnet 32 having a rectangular cross-section is used for the rotating electric machine 100 has been described. However, the permanent magnet 320 having an arc-shaped cross-section can also be used. FIG. 9 is a cross-sectional view of a main part of a magnetic pole portion 300 illustrating an example thereof. In FIG. 9, three permanent magnets 320 each extending in an arc shape in the width direction are respectively accommodated in three magnet accommodation holes 310, each of which is formed in an arc shape corresponding to the permanent magnet 32. All the three permanent magnets 320 are curved to be concave on an outer side surface 320a side.

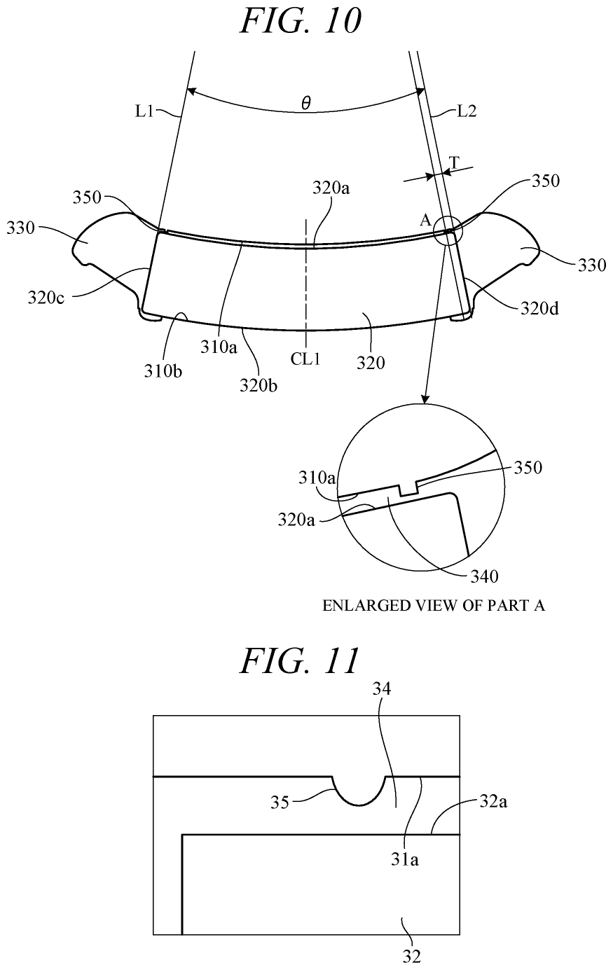

FIG. 10 is an enlarged view of a main part of FIG. 9. As illustrated in FIG. 10, a gap 340 having a substantially arc shape along the width direction of the permanent magnet 320 is provided between the outer side surface 320a of the permanent magnet 320 and an outer opposing surface 310a of the magnet accommodation hole 310. Similarly to FIG. 4, a pair of protrusions 350 are provided on the outer opposing surface 310a to protrude toward an outer side surface 320a of the permanent magnet 320. The pair of protrusions 350 are respectively located in an area between an end surface 320c of the permanent magnet 320 and a center line CL1 and an area between an end surface 320d and the center line CL1.

More specifically, the center positions in the width direction of the protrusions 350 are respectively located to be apart by the distance T from the end surfaces 320c and 320d of the permanent magnet 320, which are respectively adjacent to the flux barriers 330. In a case where θ represents a central angle of the permanent magnet 320 having an arc shape as illustrated in the drawing, the distance T is preferably set to satisfy the following formula (II).

$$0 < T \leq 0.13 \cdot θ \qquad ( II )$$

The provision of the protrusion 350 to satisfy the above formula (II) causes the magnetic flux from the stator 2 to bypass a corner portion of the permanent magnet 320 and flow across the protrusion 350 into the permanent magnet 320. Therefore, the flow of the magnetic flux is dispersed, the concentration of the magnetic flux on the corner portion of the permanent magnet 320 is alleviated, and the demagnetization of the corner portion can be suppressed. The angle θ in the above formula (II) can also be expressed as an angle formed by a virtual line L1 passing through one end surface 320c of the permanent magnet 320 and a virtual line L2 passing through the other end surface 320d, or an angle formed by the virtual lines L1 and L2, which pass through corner portions on both ends of the outer side surface 320a of the permanent magnet 320, and which are perpendicular to the outer side surface 320a.

According to the present embodiment, the following operations and effects are achievable.
(1) The rotating electric machine 100 includes: the rotor 1 that rotates about the axial line CL0; and the stator 2, which is disposed around the outer peripheral surface 1a of the rotor 1, and which generates a rotating magnetic field for the rotor 1 (FIG. 1). The rotor 1 includes: the rotor core 10 in which the plurality of magnet accommodation holes 31, 310 in the circumferential direction and the flux barrier 33, 330 adjacent to the magnet accommodation hole 31, 310 are provided; and the permanent magnet 32, 320, which has a width extending in a linear or arc shape and a thickness perpendicular to the width in a vertical cross-section perpendicular to the axial line CL0, and which is accommodated in the magnet accommodation hole 31, 310 (FIG. 2, FIG. 9). The permanent magnet 32, 320 includes the outer side surface 32a, 320a (a first surface) and the inner side surface 32b, 320b (a second surface) that respectively extend in the width direction and oppose each other (FIG. 2, FIG. 10). The magnet accommodation hole 31, 310 is formed with the outer opposing surface 31a, 310a (a first opposing surface) opposing the outer side surface 32a, 320a, and the inner opposing surface 31b, 310b (a second opposing surface) opposing the inner side surface 32b, 320b (FIG. 2, FIG. 10). The outer opposing surface 31a, 310a is located on the outer peripheral surface 1a side of the rotor 1 of the inner opposing surface 31b, 310b (FIG. 2, FIG. 9). Between the outer opposing surface 31a, 310a and the outer side surface 32a, 320a, the gap 34, 340 is provided along the width direction of the permanent magnet 32, 320 (FIG. 4, FIG. 10). The rotor core 10 includes the protrusion 35, 350 protruding from the outer opposing surface 31a, 310a toward the outer side surface 32a, 320a (FIG. 4, FIG. 10). The protrusion 35 protrudes toward a predetermined part that is on the corner portion side between the corner portion (an end portion in the width direction) of the outer side surface 32a, 320a of the permanent magnet 320 and the center portion in the width direction (the center line CL1) (FIG. 5A, FIG. 5B, FIG. 10).

With this configuration, the magnetic flux generated by the coils 21 of the stator 2 bypasses the corner portion of the permanent magnet 32, 320, and flows across the protrusion 35, 350 into the permanent magnet 32, 320. Therefore, the flow of the magnetic flux is dispersed, the concentration of the magnetic flux on the corner portion of the permanent magnet 32, 320 can be alleviated, so that the demagnetization (for example, thermal demagnetization) of the permanent magnet can be suppressed. In order to suppress the concentration of the magnetic flux on the corner portion, it is conceivable to add a large flux barrier to the corner portion. However, in the present embodiment, the provision of the protrusion 35, 350 eliminates its necessity.
(2) The permanent magnet 32 extends linearly in the width direction in a vertical cross-section perpendicular to the axial line CL0 (FIG. 2). In a case where X is defined as the length in the width direction of the permanent magnet 32, the protrusion 35 is provided so that the distance T from the corner portion to the center position in the width direction of the protrusion 35 satisfies the relationship that 0<T≤0.2·X (FIG. 4, FIG. 5A, FIG. 5B). By setting the distance T to be larger than 0 in this manner, it is possible to suppress the magnetic flux that has passed across the protrusion 35 from being guided to the corner portion of the permanent magnet 32. In addition, by setting the distance T to 0.2X or smaller, the protrusion 35 is not too apart from the corner portion. Therefore, the magnetic flux toward the corner portion bypasses the corner portion and flows across the protrusion 35, so that the concentration of the magnetic flux on the corner portion of the permanent magnet 32 can be suppressed.
(3) The permanent magnet 320 extends in an arc shape in the width direction in a vertical cross-section perpendicular to the axial line CL0 (FIG. 9). In this case, in a case where θ is defined as an angle formed by a virtual line (a first virtual line) L1 passing through one corner portion (a first end portion) in the width direction of the outer side surface 320a of the permanent magnet 320 and perpendicular to the outer side surface 320a and a virtual line (a second virtual line) L2 passing through the other corner portion (a second end portion) in the width direction and perpendicular to the outer side surface 320a, the protrusion 350 is provided so that the distance T from the corner portion to the center position in the width direction of the protrusion 350 satisfies the relationship that 0<T≤0.13·θ (FIG. 10). In a case where the permanent magnet 320 has an arc shape in this manner, the position of the protrusion 350 is set by use of the central angle θ of the arc part, so that the concentration of the magnetic flux on the corner portion of the permanent magnet 320 can be favorably suppressed.
(4) The protrusion length of the protrusion 35, 350 is shorter than the length of the gap 34, 340 which is defined as a distance from the outer opposing surface 31a, 310a to the outer side surface 32a, 320a (FIG. 5A, FIG. 5B, and FIG. 10). Accordingly, the permanent magnet 32, 320 is insertable into the magnet accommodation hole 31, 310 without contacting the edge portion of the magnet accommodation hole 31, 310, so that damage of the permanent magnet 32, 320 can be prevented.
(5) The protrusion 35, 350 has a substantially rectangular shape in the vertical cross-section perpendicular to the axial line CL0 (FIG. 5A, FIG. 5B, and FIG. 10). This increases the area of the tip end portion of the protrusion 35, 350 in close proximity to the outer side surface 32a, 320a of the permanent magnet 32, 320, so that the magnetic flux can be favorably passed across the protrusion 35, 350.
(6) The entire area in the width direction of the protrusion 35, 350 protrudes toward an area between the corner portion of the permanent magnet 32, 320 and the center portion in the width direction (the center line CL1) (FIG. 5A, FIG. 5B, and FIG. 10). That is, one side surface 35a of the protrusion 35, 350 on the corner portion side of the permanent magnet 32, 320 is located on the center line CL1 side of the corner portion, and the other side surface 35b of the protrusion 35, 350 on the center line CL1 side of the permanent magnet 32, 320 is located on the corner portion side of the center line CL1. This efficiently suppresses the magnetic flux from concentrating on the corner portion of the permanent magnet 32, 320.

The above embodiment can be varied into various forms. Several modifications will be described below. In the above embodiment (FIG. 5A and FIG. 5B), the protrusion 35 is configured to have a substantially rectangular shape in a vertical cross-section perpendicular to the axial line CL0. However, the shape of a protrusion is not limited to the above one. For example, as illustrated in FIG. 11, a distal end of the protrusion 35 may be configured to have a substantially arc shape (e.g., a semicircular shape). Thus, the protrusion 35 can be easily formed. However, when the protrusion 35 is configured to have a substantially rectangular shape, the cross-sectional area of the tip of the protrusion 35 is increased, so that more magnetic flux can be guided to the permanent magnet 32 via the protrusion 35. In view of this, it is preferable that the protrusion 35 has a substantially rectangular shape.

In the above embodiment (FIG. 4 and FIG. 10), corresponding to the pair of corners of the outer side surface 32a, 320a of the permanent magnet 32, 320, the pair of protrusions 35,350 symmetrically in the center line CL1 are provided. However, on the pair of corners of the permanent magnet, magnetic flux of the same degree as each other is not necessarily concentrated. For this reason, the pair of protrusions may be provided at positions asymmetric with respect to the center line CL1, or may be provided in shapes asymmetric with respect to the center line CL1. Depending on the arrangement of the permanent magnet, the effect of demagnetization suppression by providing the protrusion may be small. Therefore, instead of providing a pair of protrusions, a single protrusion may be provided. Among a plurality of permanent magnets, if there is a permanent magnet in which the effect of the demagnetization suppression by providing a protrusion is small, it may not be provided with a protrusion to the permanent magnet. For example, a case that the effect of demagnetization suppression for the first permanent magnet 321 (FIG. 2) by providing the protrusion 35 is smaller than the effect for the second permanent magnet 322 and the third permanent magnet 323, the protrusion 35 of the first magnet accommodation hole 31 may be omitted.

In the above embodiment (FIG. 2 and FIG. 9), three permanent magnets 32, 320 are arranged in the magnetic pole portion 30,300, the number and arrangement of the permanent magnet in the magnetic pole portion are not limited to those described above. For example, a single permanent magnet may be arranged in the magnetic pole portion, or two magnets may be arranged. That is, at the corner portion of the permanent magnet, the magnetic flux is easily concentrated regardless of the number and arrangement of the permanent magnet. Therefore, by providing a protrusion corresponding to the corner portion of the permanent magnet, regardless of the number and arrangement of the permanent magnet, it is possible to efficiently suppress that the magnetic flux is concentrated on the corner portion.

The above embodiment can be combined as desired with one or more of the above modifications. The modifications can also be combined with one another.

According to the present invention, it is possible to efficiently improve demagnetization resistance of a permanent magnet included in a rotating electric machine.

Above, while the present invention has been described with reference to the preferred embodiments thereof, it will be understood, by those skilled in the art, that various changes and modifications may be made thereto without departing from the scope of the appended claims.

What is claimed is:

1. A rotating electric machine comprising:
a rotor rotating about an axial line; and
a stator disposed around an outer peripheral surface of the rotor to generate a rotating magnetic field for the rotor, wherein
the rotor includes:
a rotor core in which a plurality of magnet accommodation holes in a circumferential direction and flux barriers are formed, each of the flux barriers being adjacent to each of the plurality of magnet accommodation holes; and
a plurality of permanent magnets, each having a width extending in a linear shape or an arc shape in a width direction and a thickness extending in a thickness direction perpendicular to the width direction, in a vertical cross-section perpendicular to the axial line, and being accommodated in the each of the plurality of magnet accommodation holes,
each of the plurality of permanent magnets includes a first surface and a second surface extending in the width direction and opposed to each other,
the each of the plurality of magnet accommodation holes is formed with a first opposing surface opposing the first surface and a second opposing surface opposing the second surface,
the first opposing surface is located further on an outer peripheral surface side of the rotor than the second opposing surface,
a gap is provided between the first opposing surface and the first surface along the width direction,
the rotor core includes a protrusion protruded from the first opposing surface toward the first surface, and
the protrusion is protruded toward a predetermined portion on a side of an end portion between the end portion and a center portion in the width direction of the first surface.

2. The rotating electric machine according to claim 1, wherein
the each of the plurality of permanent magnets is configured to extend in the linear shape in the width direction in the vertical cross-section, and
under a situation where a length in the width direction of the each of the plurality of permanent magnets is represented by X and a distance from the end portion to a center position in the width direction of the protrusion is represented by T, the protrusion is provided so as to satisfy a relation of 0<T≤0.2·X.

3. The rotating electric machine according to claim 1, wherein
the each of the plurality of permanent magnets is configured to extend in the arc shape in the width direction in the vertical cross-section, and
under a situation where an angle formed by a first virtual line passing through a first end portion in the width direction of the first surface and extending perpendicular to the first surface and a second virtual line passing through a second end portion in the width direction of the first surface and extending perpendicular to the first surface is represented by θ and a distance from the first end portion to a center position in the width direction of the protrusion is represented by T, the protrusion is provided so as to satisfy a relation of 0<T≤0.13·0.

4. The rotating electric machine according to claim 2, wherein
a protrusion length of the protrusion is shorter than a length of the gap defined as a distance from the first opposing surface to the first surface.

5. The rotating electric machine according to claim 3, wherein
a protrusion length of the protrusion is shorter than a length of the gap defined as a distance from the first opposing surface to the first surface.

6. The rotating electric machine according to claim 2, wherein
the protrusion has a substantially rectangular shape in the vertical cross-section.

7. The rotating electric machine according to claim 3, wherein
the protrusion has a substantially rectangular shape in the vertical cross-section.

8. The rotating electric machine according to claim 6, wherein
an entire area in the width direction of the protrusion is protruded to be opposed to an area between the end portion and the center portion in the width direction of the first surface.

9. The rotating electric machine according to claim 7, wherein
an entire area in the width direction of the protrusion is protruded to be opposed to an area between the end portion and the center portion in the width direction of the first surface.

10. The rotating electric machine according to claim 1, wherein
the rotor core includes a pair of protrusions disposed symmetrically with respect to a center line passing through the center portion of the first surface and extending in the thickness direction, and
each of the pair of protrusions corresponds to the protrusion.

11. The rotating electric machine according to claim 10, wherein
the pair of protrusions are a first protrusion and a second protrusion,
the first surface includes a first end portion and a second end portion in the width direction,
the first protrusion is protruded toward a predetermined portion on a side of the first end portion between the first end portion and the center line, and
the second protrusion is protruded toward a predetermined portion on a side of the second end portion between the second end portion and the center line.

12. The rotating electric machine according to claim 1, wherein
the rotor includes a plurality of magnetic pole portions in the circumferential direction,
the plurality of magnet accommodation holes include a first magnet accommodation hole, a second magnet accommodation hole and a third magnet accommodation hole, formed in each of the plurality of magnetic pole portions,
the each of the plurality of magnetic pole portions includes a first permanent magnet accommodated in the first magnet accommodation hole, a second permanent magnet accommodated in the second magnet accommodation hole, and a third permanent magnet accommodated in the third magnet accommodation hole,
the first magnet accommodation hole is extended in the circumferential direction so as to be substantially orthogonal to a d-axis passing through a center in the circumferential direction of the each of the plurality of magnetic pole portions and extending in a radial direction, and
the second magnet accommodation hole and the third magnet accommodation hole are formed symmetrically with respect to the d-axis inside the first magnet accommodation hole in the radial direction.

13. The rotating electric machine according to claim 1, wherein
the gap is filled with a resin material.
